(19) United States
(12) Patent Application Publication
(10) Pub. No.: US 2009/0015355 A1
(43) Pub. Date: Jan. 15, 2009

(54) COMPENSATED ATTENUATOR

(75) Inventor: David M. ZEEB, Mountain View, CA (US)

Correspondence Address: KOLISCH HARTWELL, P.C., 200 PACIFIC BUILDING, 520 SW YAMHILL STREET, PORTLAND, OR, 97204, US

(73) Assignee: ENDWAVE CORPORATION, San Jose, CA (US)

(21) Appl. No.: 11/777,096

(22) Filed: Jul. 12, 2007

(51) Int. Cl. H01P 1/22

(52) U.S. Cl. 333/81 A

(57) ABSTRACT

An attenuator circuit for attenuating a signal transmitted from an input circuit to an output circuit may include a ground conductor and a series impedance element providing a series resistance for coupling the input circuit to the output circuit. In some examples, a first shunt impedance element may provide a primarily capacitive reactance and couple the series impedance element to the ground conductor. In these or other examples, a second shunt impedance element may provide a primarily inductive reactance and couple the series impedance element to the ground conductor. The second shunt impedance element may be electrically separate from and may extend electrically in parallel with the first shunt impedance element.

### TECHNICAL FIELD

The present disclosure relates to attenuator circuits, and more particularly to attenuator circuits that are adapted to provide substantially constant signal attenuation over a broad frequency range.

### BACKGROUND

An attenuator may include active and/or passive circuit elements that are collectively configured to reduce the amplitude and/or the power of a signal. Because it is desirable for an attenuator to maintain the integrity of the signal it attenuates, it is preferable that the attenuator provides substantially constant signal attenuation over a broad frequency range. However, resistive (relatively lossy) and conductive (low loss or substantially lossless) elements generally do not have purely resistive impedances at some frequencies. Accordingly, attenuators fabricated with such elements may not provide substantially constant signal attenuation over all desired frequencies.

Examples of attenuators may be found in the disclosures of U.S. Pat. Nos. 2,119,195; 2,994,049; 3,227,975; 3,534,302; 3,539,459; 3,599,125; 3,680,013; 3,701,056; 3,739,305; 4,272,739; 4,349,792; 5,136,265; 5,847,624; and 5,986,516. Examples of circuits that include impedance compensation may be found in one or more of the aforementioned disclosures, or in U.S. Pat. Nos. 3,611,123; 4,090,155; and 6,600,384. Examples of planar resistive elements may be found in one or more of the aforementioned disclosures, or in U.S. Pat. Nos. 3,329,921; 3,460,026; 3,573,703; 3,594,679; 4,475,099; 4,505,032; 6,664,500; 6,677,850; and 7,030,728. The entire disclosures of each of the patents, patent applications, and patent application publications recited in this and in other paragraphs are all incorporated by reference herein in their entirety and for all purposes.

### SUMMARY

An attenuator circuit for attenuating a signal transmitted from an input circuit to an output circuit may include a ground conductor and a series impedance element providing a series resistance for coupling the input circuit to the output circuit. In some examples, a first shunt impedance element may provide a primarily capacitive reactance and couple the series impedance element to the ground conductor. In these or other examples, a second shunt impedance element may provide a primarily inductive reactance and couple the series impedance element to the ground conductor. The second shunt impedance element may be electrically separate from and may extend electrically in parallel with the first shunt impedance element.

### BRIEF DESCRIPTION OF THE DRAWINGS

FIG. 1 is a schematic representation of an attenuator circuit.

FIG. 2 is a circuit diagram of a first embodiment of a compensated attenuator circuit.

FIG. 3 is a circuit diagram of a second embodiment of a compensated attenuator circuit.

FIGS. 4-6 are partial cutaway plan views of examples of coplanar attenuator circuits embodying the compensated attenuator circuit shown in FIG. 2.

FIG. 7 is a partial cutaway plan view of an example of a coplanar attenuator circuit embodying the compensated attenuator circuit shown in FIG. 3.

FIGS. 8-10 are plan views of the cross-shaped resistive members of the coplanar attenuator circuits of FIGS. 4-6.

FIG. 11 is a generalized schematic plan view of a cross-shaped resistive assembly.

FIG. 12 is a generalized schematic plan view of an H-shaped resistive assembly.

### DETAILED DESCRIPTION

Attenuators may be employed in circuits transmitting signals such as audio frequency signals and/or radio frequency signals, including microwave and millimeter-wave signals. In some examples, an attenuator circuit may be a discrete component that is inserted into an apparatus. In other examples, an attenuator circuit may be an integral part of a multi-function component or subsystem. An attenuator may be fabricated in an arbitrary structure or as a primarily planar structure such as a circuit on a microchip or a printed circuit board, or the like.

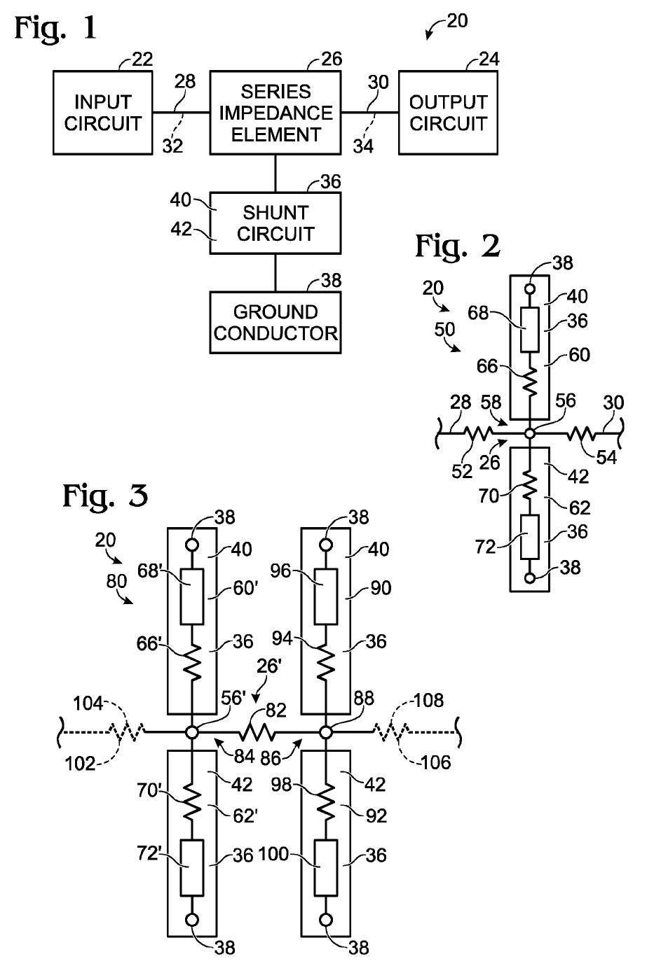

Turning now to the drawings, a schematic representation of an exemplary attenuator circuit is shown in FIG. 1 and is indicated generally at 20. Attenuator circuit 20 may be adapted to attenuate a signal transmitted from an input circuit 22 to an output circuit 24. The attenuator circuit may include a series impedance element 26 disposed in a current path between an input conductor 28 and an output conductor 30. As used herein, modifiers of components or features are intended to have their common meaning. For example in this instance, “series impedance element 26” provides series impedance in the circuit structure of which it forms a part. In this configuration, the series impedance element may couple the input circuit to the output circuit. Series impedance element 26 may include any combination of active and/or passive circuit elements that may collectively provide impedance having one or both of resistive and reactive components. The input conductor may be electrically coupled (for example, indirectly or directly connected) to series impedance element 26 for coupling the series impedance element to input circuit 22. Similarly, the output conductor may be electrically coupled (for example, indirectly or directly connected) to series impedance element 26 for coupling the series impedance element to output circuit 24. Accordingly, input conductor 28 and output conductor 30 may transmit an input signal 32 and an output signal 34, respectively.

Attenuator circuit 20 may also include one or more shunt circuits 36. A shunt circuit may include any combination of active and/or passive circuit elements that may collectively provide impedance having one or both of resistive and reactive components. The one or more shunt circuits may each couple series impedance element 26 to a ground conductor 38.

In an ideal, frequency-independent attenuator, series impedance element 26 and the one or more shunt circuits 36 each have exclusively resistive impedances. If any of these components has a net reactive impedance component, or a net effective reactive impedance component, then the signal attenuation provided by the attenuator may be dependent upon the frequency of input signal 32. Consequently, if different frequency components of non-sinusoidal input signals receive different attenuation, output signal 34 may exhibit distortion compared to input signal 32. However, components that may be included in one or both of series impedance element 26 and shunt circuit 36 may include one or more distributed resistors and/or one or more conductive elements that collectively and/or individually may provide reactance that may be capacitive, inductive, or a combination of both capacitive and inductive. In this case, for at least one frequency or within at least one range of frequencies, either the series impedance element and/or the one or more shunt circuits may include reactive components in addition to the intended resistive components. A shunt circuit 36 having impedance that includes non-zero reactive components may be considered as either a capacitive-shunt circuit 40 or an inductive-shunt circuit 42.

FIG. 2 shows a circuit diagram of an example 50 of attenuator circuit 20 that includes one or more elements that provide impedance compensation for at least one frequency of input signal 32. Compensated attenuator circuit 50, as shown, is configured as a “T” attenuator that includes at least one compensating component. Specifically, compensated “T” attenuator circuit 50 may include an input series resistor 52 electrically coupled to input conductor 28 and an output series resistor 54 electrically coupled to output conductor 30. The input and output series resistors may jointly form series impedance element 26. Input series resistor 52 and output series resistor 54 may have substantially similar resistance. Optionally, resistors 52 and 54 may have substantially similar impedance. In some embodiments, the impedance of the input and output series resistors may be primarily resistive over a range of frequencies and/or the reactance of the series resistors may be substantially insignificant or approximately zero for at least one frequency, or over at least one range of frequencies. Input series resistor 52 and output series resistor 54 may be electrically coupled at a common junction node 56. Optionally, resistors 52 and 54 may be the end portions of a single resistor 58, in which case node 56 represents an intermediate portion of resistor 58. The common junction node may be coupled to ground conductor 38 by one or more shunt circuits 36. The amount of attenuation provided by the attenuator circuit may depend upon a combination of the resistive component of the resultant impedance between common junction node 56 and ground conductor 38 provided by the one or more shunt circuits and the resistive component of the impedance of the series resistors 52 and 54. “T” attenuators may be designed to provide a specific amount of attenuation, such as 3 dB, 6 dB, 10 dB, or other amounts.

Compensated “T” attenuator circuit 50, as shown in FIG. 2, includes at least one capacitive shunt circuit 40, such as a capacitive-shunt impedance element 60, and at least one inductive shunt circuit 42, such as inductive-shunt impedance element 62. Capacitive-shunt impedance element 60 may couple series impedance 26 to ground conductor 38. The capacitive-shunt impedance element may have a first impedance that includes a first resistance and a primarily capacitive first reactance. Accordingly, capacitive-shunt impedance element 60 may include a capacitive-shunt resistor 66 and a capacitive device 68. Similarly, inductive-shunt impedance element 62 may couple the series impedance element to the ground conductor. The inductive-shunt impedance element may be electrically separate from the capacitive-shunt impedance element, and may extend electrically in parallel with the capacitive-shunt impedance element. The inductive-shunt impedance element may have a second impedance that includes a second resistance and a primarily inductive second reactance. Accordingly, inductive-shunt impedance element 62 may include only an inductive-shunt resistor 70, or resistor 70 and an inductive device 72.

In some examples, capacitive-shunt impedance element 60 and inductive-shunt impedance element 62 may be configured to provide a substantially constant resultant impedance between series impedance element 26, for example at common junction node 56, and ground conductor 38 over one or more frequency ranges. Optionally, the capacitive-shunt impedance element and the inductive-shunt impedance element may be configured to provide a primarily resistive resultant impedance between the series impedance element and the ground conductor over one or more frequency ranges. For example, the capacitive-shunt impedance element and the inductive-shunt impedance element may be configured to be electrically in parallel and provide a primarily resistive resultant impedance between the series impedance element 26 and the ground conductor from frequencies ranging from DC signals, or substantially 0 Hz, to millimeter-wave frequencies, such as 110 GHz. In some embodiments, a net reactance of the parallel combination of the capacitive-shunt impedance element and the inductive-shunt impedance element may be substantially insignificant or approximately zero for at least one frequency, or over at least one range of frequencies. This result may be achieved by the capacitance compensating for the excess inductance in the shunt circuit.

FIG. 3 depicts a circuit diagram of another example 80 of attenuator circuit 20 that includes one or more elements that provide impedance compensation for at least one frequency of the input signal. Compensated attenuator circuit 80, as shown, is configured as a “pi” attenuator that includes compensating components. Like series impedance element 26 of compensated “T” attenuator circuit 50, series impedance element 26′ of compensated “pi” attenuator circuit 80 may have impedance that is primarily resistive. Accordingly, series impedance element 26′ may include a series resistor 82. Series impedance element 26′, for example series resistor 82, may have a first end 84 and a second end 86. The first and second ends may be electrically coupled to common junction nodes 56′ and 88, respectively. The common junction nodes may be coupled to ground conductor 38 by one or more capacitive-shunt circuits 40 and/or one or more inductive-shunt circuits 42. Compensated “pi” attenuator circuit 80, therefore, may include capacitive-shunt impedance elements 60′ and 90 and inductive-shunt impedance elements 62′ and 92.

Capacitive-shunt impedance element 60′ may couple first end 84 of series impedance element 26′ to ground conductor 38. Similarly, inductive-shunt impedance element 62′ may couple the first end to the ground conductor. Capacitive-shunt impedance element 60′ may have a first impedance that includes a first resistance and a primarily capacitive first reactance. Accordingly, capacitive-shunt impedance element 60′ may include a capacitive-shunt resistor 66′ and a capacitive device 68′. Inductive-shunt impedance element 62′ may be electrically separate from capacitive-shunt impedance element 60′, and may extend electrically in parallel with capacitive-shunt impedance element 60′. Inductive-shunt impedance element 62′ may have a second impedance that includes a second resistance and a, primarily inductive second reactance. Accordingly, inductive-shunt impedance element 62′ may include an inductive-shunt resistor 70′ and a primarily inductive device 72′.

Similarly, capacitive-shunt impedance element 90 may couple second end 86 of series impedance element 26′ to ground conductor 38. Inductive-shunt impedance element 92 may couple the second end of the series impedance element to the ground conductor. Capacitive-shunt impedance element 90 may have a third impedance that includes a third resistance and a primarily capacitive third reactance. Accordingly, capacitive-shunt impedance element 90 may include a capacitive-shunt resistor 94 and a capacitive device 96. Inductive-shunt impedance element 92 may be electrically separate from capacitive-shunt impedance element 90, and may extend electrically in parallel with capacitive-shunt impedance element 90. Inductive-shunt impedance element 92 may have a fourth impedance that includes a fourth resistance and a primarily inductive fourth reactance. Accordingly, inductive-shunt impedance element 92 may include an inductive-shunt resistor 98 and an inductive device 100. As has been suggested, inductive-shunt impedance elements may each be a single device, such as a distributed resistor that also produces parasitic inductance and/or capacitance. In some examples, capacitive-shunt impedance element 60′ and capacitive-shunt impedance element 90 may have substantially similar impedance. Additionally or alternatively, inductive-shunt impedance element 62′ and inductive-shunt impedance element 92 may have substantially similar impedance.

In some examples, capacitive-shunt impedance elements 60′ and 90 and inductive-shunt impedance elements 62′ and 92 may be configured to provide a substantially constant resultant impedance between series impedance element 26′ at, for example, first end 84, second end 86, and/or an intermediate portion of the series impedance element, and ground conductor 38 over one or more frequency ranges. Optionally, the capacitive-shunt impedance elements and the inductive-shunt impedance elements may be configured to provide a primarily resistive resultant impedance between the ground conductor and the series impedance element over one or more frequency ranges. For example, the capacitive-shunt impedance elements and the inductive-shunt impedance elements may be configured to provide a primarily resistive resultant impedance between the ground conductor and the series impedance element 26′ from frequencies ranging from DC signals, or substantially 0 Hz, to microwave or millimeter-wave frequencies, such as 110 GHz. In some embodiments, the reactance of the one or more parallel combinations of the capacitive-shunt impedance elements and the inductive-shunt impedance elements may be substantially insignificant or approximately zero for at least one frequency, or over at least one range of frequencies.

Series impedance element 26′ of compensated attenuator circuit 80 may be adapted to couple the input circuit to the output circuit. In some examples, the input conductor may be coupled to first end 84 of series resistor 82, and the output conductor may be coupled to second end 86. In the example shown in FIG. 3, attenuator circuit 80 includes an input impedance device 102, such as input resistor 104, coupled in series between the input conductor and the first end. Additionally, the illustrated attenuator circuit includes an output impedance device 106, such as output resistor 108, coupled in series between the output conductor and the second end. A compensated “pi” attenuator may include only input impedance device 102, only output impedance device 106, a combined impedance device, or neither of these impedance devices.

The amount of attenuation provided by the attenuator circuit may depend upon the resistive components of the resultant impedances between common junction nodes 56′ and 88 and ground conductor 38 provided by the respective shunt circuits and the resistive component of series impedance element 26′. In examples that include input and/or output impedance devices, the resistive components of these elements may also determine the amount of attenuation. Compensated “pi” attenuator circuits that provide 3 dB, 6 dB, 10 dB, or other amounts of signal attenuation may be provided.

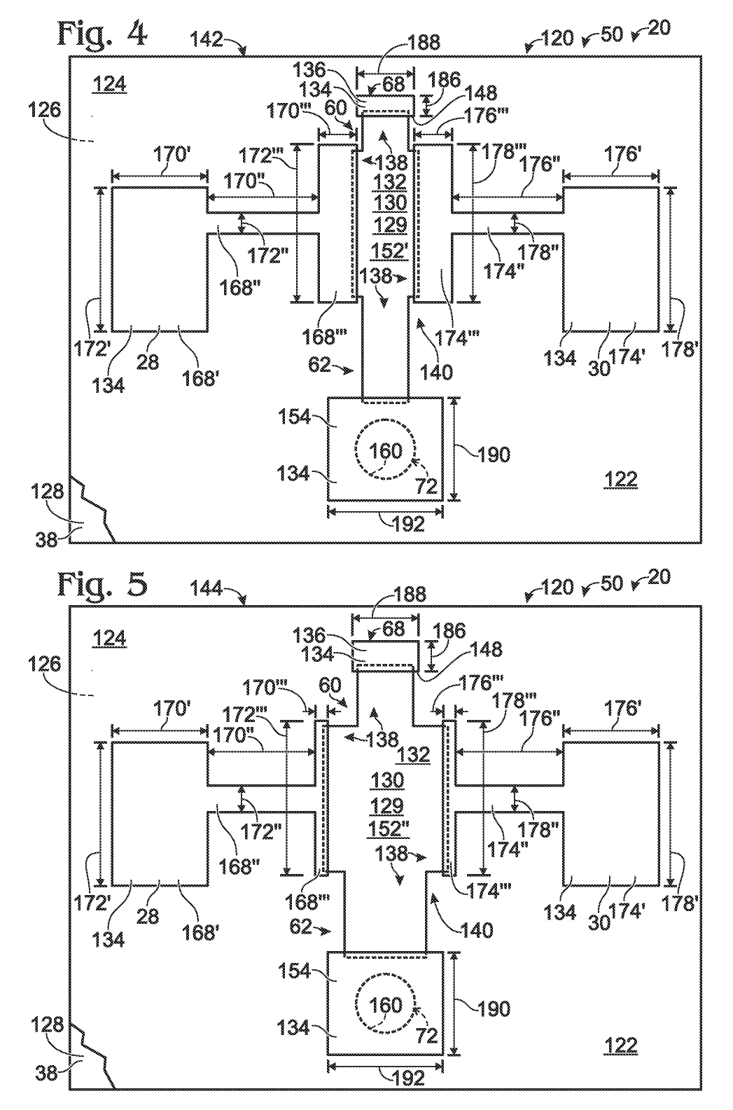

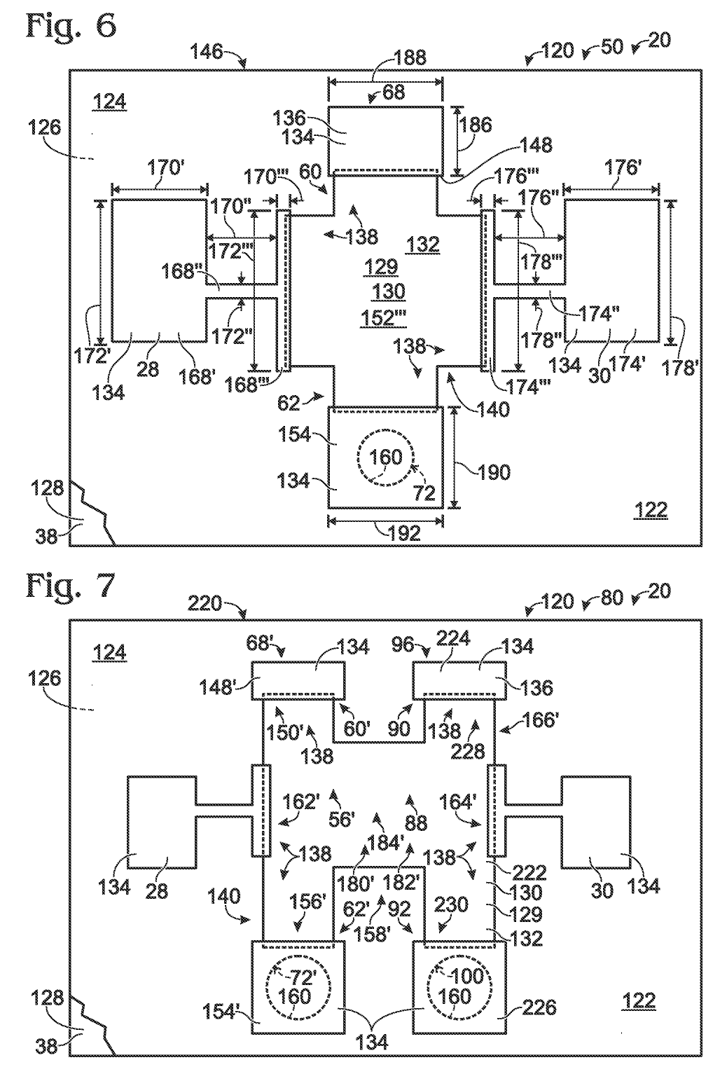

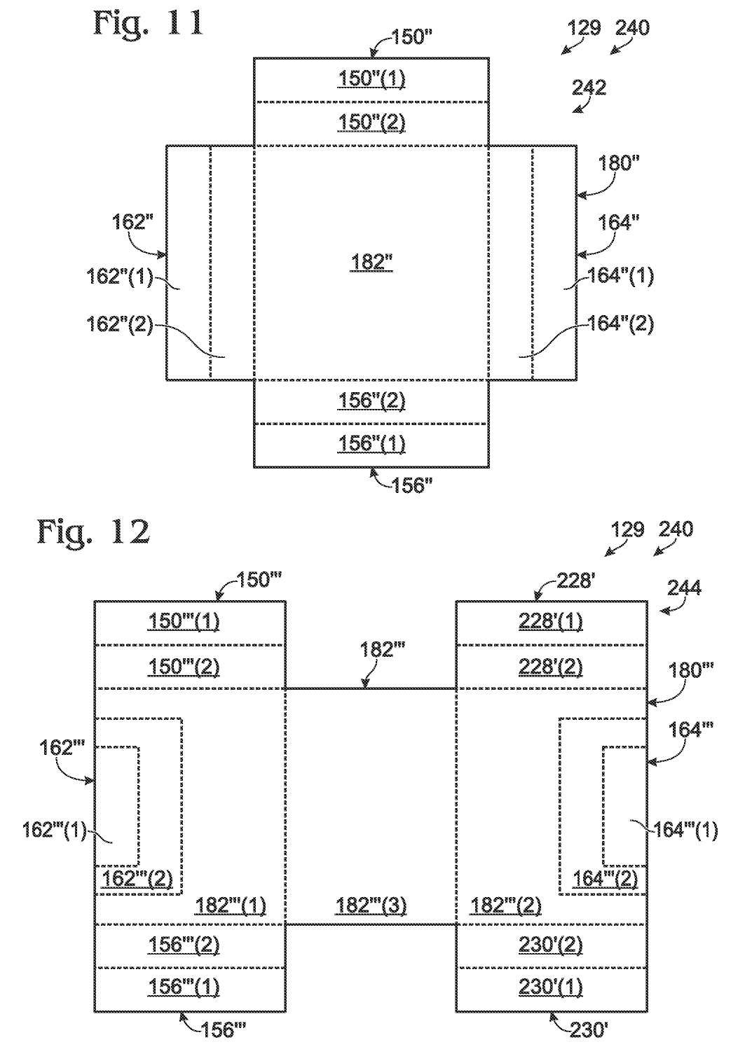

Compensated attenuator circuits 50 and 80 may be fabricated in a number of ways. For example, discrete components may be assembled according to the circuit diagrams shown in FIGS. 2-3. In other examples, the compensated attenuator circuits may be fabricated on a substrate or similar workpiece, as shown in FIGS. 4-7. Coplanar attenuator circuits 120, as shown in FIGS. 4-7, may each include an insulating substrate 122 having a first surface 124 opposite a second surface 126. A planar ground conductor 128 embodying ground conductor 38 may extend along the second surface. The coplanar attenuator circuit may include one or more components that may be formed on the first surface. For example, a resistive assembly 129 shown in these embodiments as a resistive member 130, may provide one or more of the resistors or resistance devices of compensated attenuator circuit 50 or 80, and may be fabricated at least in part from at least a portion of a resistive layer 132 that extends along the first surface. As described more generally below with reference to FIGS. 11 and 12, resistive assembly 129 may be formed as a combination of resistive and conductive segments or elements.

Coplanar attenuator circuits 120 may include one or more conductive elements 134 that may be fabricated from at least a portion of an electrically conductive layer 136 that extends along first surface 124 opposite the planar ground conductor. Each conductive element may contact a corresponding segment 138 of resistive member 130 and may form electrical coupling to the resistive member. Each segment 138 may be disposed along a perimeter 140 of resistive member 130. Perimeter 140 may form any suitable shape, such as the polygons shown in the figures. As also shown in the figures, the conductive elements overlap the resistive member. However, it is within the scope of this disclosure that the perimeter of the resistive member form curvilinear shapes, and/or that the resistive member may overlap the conductive elements, or may make electrical contact or be coupled in any suitable manner.

Dimensions of one or more components of resistive member 130 and/or one or more conductive elements 134 may include a length and/or a width. The terms “length” and “width” are intended to refer to dimensions generally without reference to the relative size of other related dimensions of the object described and/or claimed using these terms. Specifically, as used herein, the length of a component or an element is the dimension of the component or element along the general direction of current flow through the component or element. Similarly, the width of a component or an element is the dimension of the component or element that is generally transverse to the general direction of current flow through the component or element.

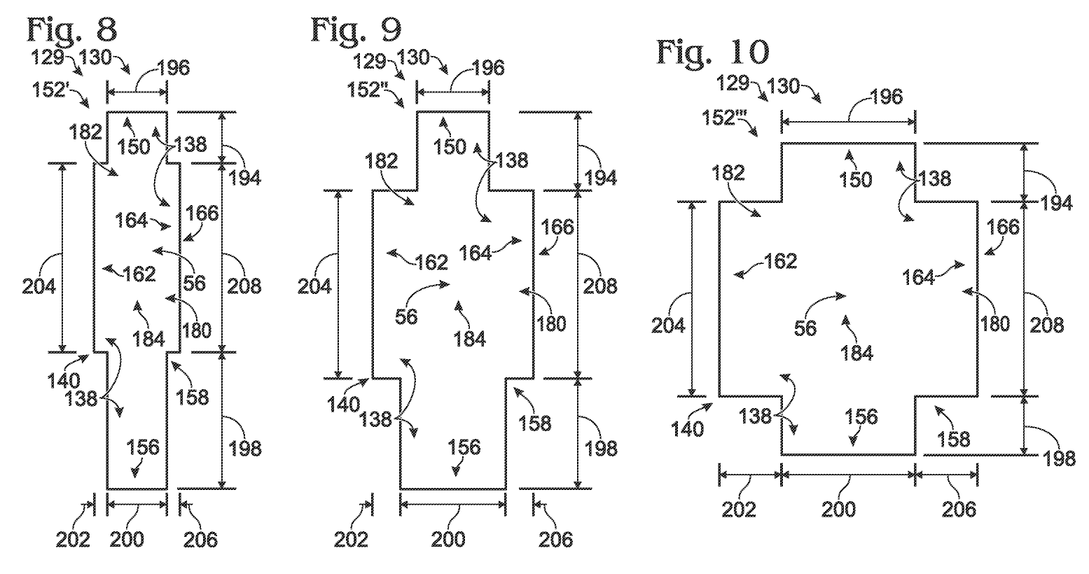

Referring specifically now to FIGS. 4-6, three examples of coplanar attenuator circuits 120 that embody compensated “T” attenuator circuit 50 are shown, and are indicated at 142, 144, and 146. Resistive members 130 of coplanar attenuator circuits 142, 144, and 146 are shown in more detail in FIGS. 8, 9, and 10, respectively. Examples of one or more features that resistive members 130 may have are shown in FIGS. 4-6, and in FIGS. 8-10.

The one or more conductive elements 134 of coplanar attenuator circuits 142, 144, or 146 may include an open-circuit ground shunt conductor 148 that may be electrically coupled to a first segment 150 of a cross-shaped resistive member 152, and may extend from the first segment. Coplanar attenuators 142, 144, and 146 may include cross-shaped resistive members 152, 152″, and 152′″, respectively. The open-circuit ground shunt conductor may capacitively couple first segment 150 to ground conductor 128. Open-circuit ground shunt conductor 148, planar ground conductor 128, and a portion of insulating substrate 122 may cooperatively form at least a portion of capacitive device 68. Accordingly, open-circuit ground shunt conductor 148 and first segment 150 may form capacitive-shunt impedance element 60 of compensated attenuator circuit 50.

In some examples, first segment 150, planar ground conductor 128, and a portion of insulating substrate 122 may cooperatively form at least a portion of capacitive device 68. Optionally, open-circuit ground shunt conductor 148 may not be used, and the capacitive reactance of the capacitive-shunt impedance element may be provided exclusively by the combination of the first segment of the resistive member, the planar ground conductor, and the portion of the insulating substrate. In other examples, other capacitor structures may be used, such as coplanar capacitors, interdigitated coplanar capacitors, metal-insulator-metal (MIM) capacitors, flip chip capacitors, beam lead capacitors, gap capacitors, or discrete component capacitors.

The one or more conductive elements may also include a terminating ground shunt conductor 154 that may be electrically coupled to a second segment 156 of the cross-shaped resistive member and may extend from the second segment. The second segment may be disposed on a first side 158 of the cross-shaped resistive member that is spaced from, and may be substantially opposite the side on which the first segment is disposed. As used in this instance, the term “opposite” refers to opposite sides of the resistive member relative to a line extending between the input and the output ends of the resistive member.

One or more coupling conductors such as connecting conductors 160 may extend between planar ground conductor 128 and first surface 124 of insulating substrate 122. The terminating ground shunt conductor may be electrically coupled to the ground conductor by means of the one or more connecting conductors. The coupling of the terminating ground shunt conductor to the ground conductor through the one or more connecting conductors may provide at least a portion of inductive device 72. Accordingly, terminating ground shunt conductor 154 and second segment 156 may form inductive-shunt impedance element 62 of compensated attenuator circuit 50. Optionally, the resistive member may be coupled directly to ground, such as when the ground conductor is disposed on first surface 124.

Conductive elements 134 may include input conductor 28 and/or output conductor 30 that may be electrically coupled to a third segment 162 and a fourth segment 164, respectively, of the resistive member. The input and output conductors may extend from the third and fourth segments. The third segment may be disposed between first segment 150 and second segment 156. The fourth segment may be disposed on a second side 166 of the resistive member that is, in this example, substantially opposite the side on which the third segment is disposed. In examples where perimeter 140 forms a polygon, first side 158 and/or second side 166 may each lie along a side of the polygon. Optionally, the first side and the second side may lie on adjacent sides of the polygon.

Input conductor 28 may include a plurality of serially coupled segments 168. Each segment may have a substantially uniform length 170 and a substantially uniform width 172. A first segment 168′, having a length 170′ and a width 172′, may be electrically coupled to a second segment 168″ having a length 170″ and a width 172″. The second segment may be electrically coupled to a third segment 168′″ having a length 170′″ and a width 172′″, and may be disposed between the first segment and the third segment. The third segment may be electrically coupled to resistive member 130. Optionally, width 172″ may be less than width 172′ and/or width 172′″.

Similarly, output conductor 30 may include a plurality of serially coupled segments 174. Each segment may have a substantially uniform length 176 and a substantially uniform width 178. A first segment 174′, having a length 176′ and a width 178′, may be electrically coupled to a second segment 174″ having a length 176″ and a width 178″. The second segment may be electrically coupled to a third segment 174′″ having a length 176′″ and a width 178′″, and may be disposed between the first segment and the third segment. The third segment may be electrically coupled to resistive member 130. Optionally, width 178″ may be less than width 178′ and/or width 178′″. Whereas segments 168 and 174 are described and shown as having rectangular shapes, it is within the scope of this disclosure that the input and output conductors, and their component segments, have other shapes or forms. Moreover, input conductor 28 and output conductor 30 may not have the mirrored geometry shown in the figures.

Cross-shaped resistive members 152′, 152″, and 152′″ may each provide distributed resistances that may provide the resistances and/or the resistive components of the impedances of one or more components of coplanar attenuator circuits 142, 144, and 146. For example, the cross-shaped resistive members may each include a base segment 180 that extends between input conductor 28 and output conductor 30. Accordingly, the base segment may include third segment 162, fourth segment 164, and an intermediate segment 182 that extends between the third and fourth segments. The base segment may provide at least a portion of the series impedance element, including at least a portion of the input series resistor and the output series resistor. Correspondingly, common junction node 56 may be disposed in a central region 184 of each cross-shaped resistive member at intermediate segment 182.

First segment 150 may extend laterally away from intermediate segment 182 in a first direction. Second segment 156 may extend laterally away from the intermediate segment in a second direction that is substantially opposite the first direction. First segment 150 may provide at least a portion of the capacitive-shunt resistor, and second segment 156 may provide at least a portion of the inductive-shunt resistor.

FIGS. 4-6 show embodiments of coplanar attenuator circuit 120 that include similar structural features. However, coplanar attenuator circuits 142, 144, and 146, as shown, have varying dimensions of one or more structural components. For example, relative dimensions of the various subcomponents of cross-shaped resistive members 152′, 152″, and 152′″ may vary from one embodiment to another, as shown in FIGS. 8-10. For example, first segment 150 may have a substantially uniform length 194 and a substantially uniform width 196. Similarly, second segment 156 may have a substantially uniform length 198 and a substantially uniform width 200. In some examples such as cross-shaped resistive members 152′ and 152″ shown in FIGS. 8-9, length 194 may be different from length 198. Additionally or alternatively, width 196 may be different from width 200, such as shown in cross-shaped resistive member 152″ shown in FIG. 9. Moreover, embodiments may have different lengths and/or widths. Different dimensions for these lengths and widths may provide different impedances, resistive and reactive, for both capacitive-shunt impedance element 60 and inductive-shunt impedance element 62.

Additionally or alternatively, third segment 162 may have a substantially uniform length 202 and a substantially uniform width 204. Similarly, fourth segment 164 may have a substantially uniform length 206 and a substantially uniform width 208. In some examples, length 202 may be different from length 206. In other examples, width 204 may be different from width 208. Moreover, embodiments may have different widths and/or lengths. Different dimensions for these lengths and widths may provide different impedances, resistive and reactive, for both the input series resistor and the output series resistor. In the embodiments shown in FIGS. 4-6 and 8-10, the dimensions of the third and the fourth segments are substantially equal. In other embodiments, these dimensions may be substantially different. Whereas open-circuit ground shunt conductor 148, first segment 150, second segment 156, third segment 162, and fourth segment 164 are all shown and described as having rectangular shapes, it is within the scope of this disclosure that any of all of these features have other shapes or forms. Moreover, cross-shaped resistive members may have symmetries or asymmetries different from those shown and described.

Additionally or alternatively, lengths 170 and 176 and/or widths 172 and 178 of segments 168 and 174 of input conductor 28 and output conductor 30, respectively, may vary from one embodiment to another. As would be known to one skilled in the art, varying the relative dimensions of these conductive segments would produce variations in the characteristic impedances and electrical lengths of the transmission line segments which form the input conductor or the output conductor. Therefore, the input and output conductor dimensions may be varied to provide additional impedance matching within the attenuator or to external circuits.

Additionally or alternatively, a substantially uniform length 186 and/or a substantially uniform width 188 of open-circuit ground shunt conductor 148 may vary from one embodiment to another. Varying the area of the open-circuit ground shunt conductor may alter the capacitance of capacitive device 68, or the reactive component of the first impedance. Similarly, a length 190 and/or a width 192 of terminating ground shunt conductor 154 may vary. Varying the dimensions of this component may affect the capacitance and/or inductance of inductive-shunt impedance element 62 of coplanar attenuator circuits 142, 144, and 146.

Coplanar attenuator circuits 142, 144, and 146 have been constructed on 100-micron-thick gallium arsenide (GaAs) substrates to provide respective attenuation levels of approximately 3 dB, 6 dB, and 10 dB over one or more frequency ranges such as 0 to 110 GHz, or lesser or greater ranges depending, at least partially, upon the maximum acceptable deviations from the desired attenuation level. Consequentially, the embodiments may provide specific levels of attenuation and/or may provide substantially equal levels of attenuation over specific ranges of input frequencies.

Referring again to FIG. 7, an example 220 of coplanar attenuator circuit 120 that may provide an embodiment of compensated “pi” attenuator circuit 80 is shown. Coplanar attenuator circuit 220 may include structural features that are similar to structural features described previously in reference to coplanar attenuator circuits 142, 144, and 146. The discussion that follows will refer to similar structural features of coplanar attenuator circuit 220 with similar names and reference numbers as the previous discussion of coplanar attenuator circuits 142, 144, and 146. Further, the structural features of coplanar attenuator circuit 220 may have specific dimensions in order to provide specific levels of attenuation and/or substantially equal levels of attenuation over specific ranges of input frequencies, such as shown and described previously in reference to coplanar attenuator circuits 142, 144, and 146. Moreover, other attenuator circuit layouts may be modified to include the compensating components discussed herein.

Specifically, coplanar attenuator circuit 220 may include a plurality of conductive elements 134 that may each contact a corresponding segment 138 of an H-shaped resistive member 222, and may each form electrical coupling to the resistive member. The one or more conductive elements of coplanar attenuator circuit 220 may include a first open-circuit ground shunt conductor 148′, a second open-circuit ground shunt conductor 224, a first terminating ground shunt conductor 154′, and a second terminating ground shunt conductor 226. First open-circuit ground shunt conductor 148′ may be electrically coupled to a first segment 150′ of H-shaped resistive member 222, and may extend from the first segment. First terminating ground shunt conductor 154′ may be electrically coupled to a second segment 156′ of H-shaped resistive member 222 and may extend from the second segment. Similarly, second open-circuit ground shunt conductor 224 may be electrically coupled to a fifth segment 228 of H-shaped resistive member 222, and may extend from the fifth segment. Second terminating ground shunt conductor 226 may be electrically coupled to a sixth segment 230 of H-shaped resistive member 222 and may extend from the sixth segment. Second segment 156′ and/or sixth segment 230 may be disposed on a first side 158′ of the resistive member that is spaced from, and may be substantially opposite the side on which the first and/or fifth segments are disposed. As used in this instance, the term “opposite” refers to opposite sides of the resistive member relative to a line extending between the input and the output ends of the resistive member. Optionally, fourth segment 164′ may be disposed on a second side 166′ of the resistive member that is, in this example, substantially opposite the side on which third segment 162′ is disposed.

H-shaped resistive member 222 may provide distributed resistance that may provide a resistance and/or a resistive component of the impedance of coplanar attenuator circuit 220. For example, the H-shaped resistive member may include a base segment 180′ that extends between input conductor 28 and output conductor 30. Accordingly, the base segment may include a third segment 162′, a fourth segment 164′, and an intermediate segment 182′ that extends between the third and fourth segments. In examples of attenuator circuits that include input and output resistors, the base segment, including the third segment, the intermediate segment, and the fourth segment, may provide at least a portion of the series impedance element such as the series resistor, at least a portion of the input resistor and at least a portion of the output resistor. In examples that do not include input and output resistors, the third and fourth segments may provide at least a portion of the series impedance element such as the series resistor and at least a portion of the capacitive-shunt resistors and/or the inductive-shunt resistors.

Similarly, first segment 150′ and fifth segment 228 may provide at least a portion of the capacitive-shunt resistors. Second segment 156′ and sixth segment 230 may provide at least a portion of the inductive-shunt resistors. Correspondingly, common junction nodes 56′ and 88 may be disposed in a central region 184′ of H-shaped resistive member 222 at intermediate segment 182′. Open-circuit ground shunt conductor 148′, planar ground conductor 128, and a portion of insulating substrate 122 may cooperatively form capacitive device 68′. Similarly, open-circuit ground shunt conductor 224, planar ground conductor 128, and a portion of insulating substrate 122 may cooperatively form capacitive device 96.

One or more connecting conductors 160 may extend between planar ground conductor 128 and first surface 124 of insulating substrate 122. First and second terminating ground shunt conductors 154′ and 226 may be electrically coupled to the ground conductor using one or more connecting conductors. The coupling of the terminating ground shunt conductor to the ground conductor through the one or more connecting conductors may provide at least a portion of inductive devices 72′ and/or 100 of attenuator circuit 80.

Accordingly, one or more components of coplanar attenuator circuit 220 may form the shunt circuits of compensated attenuator circuit 80, such as capacitive-shunt impedance elements 60′ and 90 and inductive-shunt impedance elements 62′ and 92. For example, first open-circuit ground shunt conductor 148′ and first segment 150′ may form capacitive-shunt impedance element 60′, and second open-circuit ground shunt conductors 224 and fifth segment 228 may form capacitive-shunt impedance element 90. Similarly, first terminating ground shunt conductor 154′ and second segment 156′ may form inductive-shunt impedance element 62′, and second terminating ground shunt conductor 226 and sixth segment 230 may form inductive-shunt impedance element 92.

As shown and described, coplanar attenuator circuits 142, 144, 146, and 220 include a resistive member 130 corresponding to resistive assembly 129. In some embodiments of coplanar attenuators 120, a resistive assembly 240, corresponding to resistive assembly 129 shown in FIGS. 4-7, may be used that includes one or more conductive elements or segments in addition to one or more resistive elements, instead of a purely resistive member 130. Optionally, the resistive elements may have varying resistances and/or shapes. For example, FIG. 11 shows another example of a resistive assembly 240 in the form of a cross-shaped resistive assembly 242 corresponding in shape to the previously described resistive members 130. Cross-shaped resistive assembly 242 includes a base segment 180″, as well as a first segment 150″ and a second segment 156″ that each extend laterally from the base segment. Base segment 180″ may include an intermediate segment 182″ that electrically connects and extends between the first segment, the second segment, a third segment 162″ and a fourth segment 164″.

Each one of segments 150″, 156″, 162″, 164″, and 182″ may be formed of at least a portion of one or more conductive layers and/or one or more resistive layers. In examples in which all of these segments are fabricated from a resistive layer, cross-shaped resistive assembly 242 may form cross-shaped resistive members 152′, 152″, or 152′″. In some examples, intermediate segment 182″ may be fabricated from at least a portion of a conductive layer, or may be a combination of conductive and resistive layers. In these examples, segments 150″, 156″, 162″, and 164″ may provide substantially all of capacitive shunt resistor 66, inductive shunt resistor 70, input series resistor 52, and output series resistor 54, respectively, of compensated “T” attenuator circuit 50 shown in FIG. 2.

In other examples, the first, second, third, and fourth segments may each be fabricated from at least a portion of a resistive layer, with the balance fabricated from at least a portion of a conductive layer. For example, first segment 150″ may include an outer segment portion 150″(1) and an inner segment portion 150″(2). Similarly, second segment 156″ may include an outer segment portion 156″(1) and an inner segment portion 156″(2). Third segment 162″ may include an outer segment portion 162″(1) and an inner segment portion 162″(2). Fourth segment 164″ may include an outer segment portion 164″(1) and an inner segment portion 164″(2). In some embodiments, one or more of the inner segment portions may be fabricated from at least a portion of a conductive layer, and the corresponding ones of the outer segment portions may be fabricated from at least a portion of one or more resistive layers. Optionally, each outer segment portion may be fabricated from a different resistive layer with differing sheet resistances in order to achieve target resistances or resistive components of impedance. Additionally or alternatively, material may be added to or removed from one or more inner or outer segment portion as each coplanar attenuator is produced, in order to achieve target resistance or resistive component of impedance on an individual attenuator circuit basis.

Similarly, FIG. 12 shows another example of resistive assembly 240 in the form of an H-shaped resistive assembly 244. H-shaped resistive assembly 244 includes a base segment 180′″. Further, a first segment 150′″, a second segment 156′″, a fifth segment 228′, and a sixth segment 230′ each extend laterally from the base segment. Base segment 180′″ may include a first outer intermediate segment portion 182′″(1) that electrically connects and extends between the first and second segments, a second outer intermediate segment portion 182′″(2) that electrically connects and extends between the fifth and sixth segments, an inner intermediate segment portion 182′″(3) that electrically connects and extends between the first and second outer intermediate segment portions, a third segment 162′″, and a fourth segment 164′″. As shown, the third and fourth segments are disposed in an interior position relative to intermediate segment 182′″. However, the third and/or fourth segments, in other embodiments, may project at least in part outwards from the intermediate segment. Each one of segments 150′″, 156′″, 162′″, 164′″, 182′″, 228′ and 230′ may be formed of at least a portion of one or more conductive or resistive layers. In examples in which all of these segments are fabricated from a resistive layer, H-shaped resistive assembly 244 may form H-shaped resistive member 222 shown in FIG. 7. In some examples, the outer intermediate segment portions may be fabricated from at least a portion of a conductive layer. In these examples, segments and/or segment portions 150′″, 228′, 156′″, 230′, and 182′″(3) collectively may provide substantially all of capacitive shunt resistors 66′ and 94, inductive shunt resistors 70′ and 98, and series resistor 82, respectively, of compensated “pi” attenuator circuit 80 shown in FIG. 3.

In other examples, the first, second, third, fourth, fifth and sixth segments may each include a segment portion that is fabricated from at least a portion of a resistive layer, with the balance fabricated from at least a portion of a conductive layer. For example, first segment 150″ may include an outer segment portion 150″(1) and an inner segment portion 150″(2). Similarly, second segment 156″ may include an outer segment portion 156″ (1) and an inner segment portion 156″ (2). Third segment 162″ may include an outer segment portion 162″(1) and an inner segment portion 162″(2). Fourth segment 164″ may include an outer segment portion 164″(1) and an inner segment portion 164″(2). Fifth segment 228′ may include an outer segment portion 228′(1) and an inner segment portion 228′(2). Sixth segment 230′ may include an outer segment portion 230′(1) and an inner segment portion 230′(2). In some embodiments, one or more of the inner segment portions may be fabricated from at least a portion of a conductive layer, with the corresponding ones of the outer segment portions fabricated from at least a portion of one or more resistive layers. Optionally, each outer segment portion may be fabricated from a different resistive layer with differing sheet resistances in order to achieve target resistance or resistive component of reactance. Additionally or alternatively, material may be added to and/or removed from one or more inner or outer segment portion as each coplanar attenuator is produced, in order to achieve target resistance or resistive component of impedance on an individual attenuator circuit basis.

Resistive members 130 or resistive assemblies 240 may have perimeters that form any suitable shape, instead of the polygons shown in the figures. In examples in which the resistive assembly includes both conductive elements and resistive elements, one or more conductive elements may overlap one or more resistive elements, one or more resistive elements may overlap one or more conductive elements, or a combination of these. Further, it is within the scope of this disclosure that the perimeters of resistive assemblies and/or resistive members form curvilinear shapes, and/or that resistive assemblies and/or members overlap the conductive elements or otherwise make electrical contact or are coupled in any suitable manner. Moreover, the shape of resistive assemblies and/or resistive members may have any symmetries and/or asymmetries as suggested previously.

Coplanar attenuator circuits 120 may be fabricated from a variety of materials. For example, gallium arsenide (GaAs) may be used as insulating substrate 122. The substrate may have single crystal, polycrystalline, amorphous, or a combination of these forms. For example, alumina, fused silica, sapphire, or similar materials may be used. Conductive elements, such as planar ground conductor 128 and conductive elements 134, may be fabricated from appropriate conductive metals such as gold, aluminum, silver, or copper. In some examples, adhesive layers such as titanium or the like may be used. Resistive elements, such as resistive member 152 or 222, may be fabricated from materials such as metallic alloys, such as Nichrome or other alloys of nickel and chromium, metallic compounds such as tantalum nitride (TaN), or other appropriate materials.

The aforementioned dimensions of one or more components of coplanar attenuator circuits 120 such as coplanar attenuator circuits 142, 144, 146, or 220 may be determined in a number of ways. For example, computerized modeling of a resulting circuit may be conducted. The designer may iteratively modify the layout of the coplanar attenuator circuit and model the resulting circuit until the desired attenuator performance metrics have been achieved at a desired frequency or within a desired range or ranges of frequencies. Optionally, a prototype circuit may be fabricated to verify design parameters.

Compensated attenuator circuits such as those described herein may be used in any application in which a reduction in amplitude of a broadband signal is desired. For example, electronic devices that transmit broadband signals, that receive broadband signals, or that both transmit and receive broadband signals may use one or more compensated attenuators.

In some examples, an attenuator circuit for attenuating a signal transmitted from an input circuit to an output circuit may comprise a ground conductor; a series impedance element providing a series resistance for coupling the input circuit to the output circuit; a first shunt impedance element providing a primarily capacitive reactance and coupling the series impedance element to the ground conductor; and a second shunt impedance element providing a primarily inductive reactance and coupling the series impedance element to the ground conductor, the second shunt impedance element electrically separate from and extending electrically in parallel with the first shunt impedance element.

In other examples, an attenuator circuit may comprise a ground conductor; an input conductor; an output conductor; a series impedance element providing a series resistance and disposed in a current path between the input conductor and the output conductor; and a first shunt circuit that includes a first shunt impedance element and a second shunt impedance element, the first and second shunt impedance elements providing parallel current paths to the ground conductor from a first common junction node associated with the series impedance element, the first shunt impedance element providing a first impedance that includes a first resistance and a primarily capacitive first reactance, the second shunt impedance element providing a second impedance that includes a second resistance and a primarily inductive second reactance.

In some examples, a coplanar attenuator may comprise an insulating substrate having a first surface opposite a second surface; a planar ground conductor extending along the second surface; a resistive assembly including a plurality of segments fabricated from at least a portion of a resistive layer extending along the first surface; one or more connecting conductors extending between the ground conductor and the first surface of the insulating substrate; and a plurality of conductive elements that are each fabricated from a portion of an electrically conductive layer extending along the first surface, the plurality of conductive elements including an open-circuit, first ground shunt conductor electrically coupled to and extending from a first segment of the resistive assembly, the first ground shunt conductor capacitively coupling the first segment to the planar ground conductor, a second ground shunt conductor electrically coupled to and extending between a second segment of the resistive assembly and a corresponding connecting conductor, the second segment being on a first side of the resistive assembly substantially opposite the first segment, an input conductor electrically coupled to and extending from a third segment of the resistive assembly, the third segment being disposed between the first segment and the second segment, and an output conductor electrically coupled to and extending from a fourth segment of the resistive assembly, the fourth segment being disposed on a second side of the resistive assembly substantially opposite the third segment.

This disclosure may include one or more independent or interdependent inventions directed to various combinations of features, functions, elements and/or properties. While examples of apparatus and methods are particularly shown and described, many variations may be made therein. Various combinations and sub-combinations of features, functions, elements and/or properties may be claimed in one or more related applications. Such variations, whether they are directed to different combinations or directed to the same combinations, whether different, broader, narrower or equal in scope, are regarded as included within the subject matter of the present disclosure.

The described examples are illustrative and directed to specific examples of apparatus and/or methods rather than a specific invention, and no single feature or element, or combination thereof, is essential to all possible combinations. Thus, any one of various inventions that may be claimed based on the disclosed example or examples does not necessarily encompass all or any particular features, characteristics or combinations, unless subsequently specifically claimed. As used herein, the terms “couple”, “coupled” or “coupling” may be used to indicate indirect or direct coupling via any selection or combination of capacitive, inductive, resistive, or distributed means, or via direct conductive connection. Where “a” or “a first” element or the equivalent thereof is recited, such usage includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically indicated. As used herein, the terms “assembly”, “member”, “element”, “portion”, “segment”, and “section”, are used synonymously to identify different described subject matter and may refer to a group of distinct items, to an item formed as a combination of parts, or as a part of an item.

### INDUSTRIAL APPLICABILITY

The methods and apparatus described in the present disclosure are applicable to electronic circuits, and to industries in which electronic circuits are used.

I claim:

1. An attenuator circuit for attenuating a signal transmitted from an input circuit to an output circuit, comprising:
a ground conductor;
a series impedance element providing a series resistance for coupling the input circuit to the output circuit;
a first shunt impedance element providing a primarily capacitive reactance and coupling the series impedance element to the ground conductor; and
a second shunt impedance element providing a primarily inductive reactance and coupling the series impedance element to the ground conductor, the second shunt impedance element electrically separate from and extending electrically in parallel with the first shunt impedance element.

2. The attenuator circuit of claim 1, wherein the first shunt impedance element and the second shunt impedance element are configured to provide a substantially constant resultant impedance between the series impedance element and the ground conductor over a frequency range.

3. The attenuator circuit of claim 2, wherein the frequency range is at least partially between 0 Hz and 110 GHz.

4. The attenuator circuit of claim 1, wherein the first shunt impedance element and the second shunt impedance element are configured to provide a primarily resistive resultant impedance between the series impedance element and the ground conductor over a frequency range.

5. The attenuator circuit of claim 1, further comprising an insulating substrate having a first surface opposite a second surface;
wherein the ground conductor extends along the second surface; and
wherein the first shunt impedance element includes a first shunt resistor extending along the first surface, the first shunt resistor providing resistive and capacitive coupling to the ground conductor.

6. The attenuator circuit of claim 1, further comprising an insulating substrate having a first surface opposite a second surface;
wherein the ground conductor extends along the second surface; and
wherein the first shunt impedance element includes a first shunt resistor and a first shunt capacitive device, the first shunt capacitive device including a portion of an electrically conductive layer that extends along the first surface opposite the ground conductor and provides at least a portion of the capacitive coupling to the ground conductor.

7. The attenuator circuit of claim 1, wherein the first shunt impedance element includes a first shunt resistor and the second shunt impedance element includes a second shunt resistor, the attenuator circuit further comprising:
an insulating substrate having a first surface opposite a second surface; and
a resistive assembly formed at least partially from at least a portion of a resistive layer that extends along the first surface, the resistive assembly including the series impedance element, the first shunt resistor, and the second shunt resistor.

8. The attenuator circuit of claim 7, wherein the resistive assembly further includes at least a portion of at least one conductive element electrically disposed between the first shunt resistor and the second shunt resistor.

9. The attenuator circuit of claim 7, further comprising an input conductor electrically coupled to the series impedance element for coupling the series impedance element to the input circuit and an output conductor electrically coupled to the series impedance element for coupling the series impedance element to the output circuit,
wherein the resistive assembly includes:
a base segment including the series impedance element and extending between the input conductor and the output conductor,
a first segment providing at least a portion of the first resistance and extending laterally from the base segment in a first direction, and
a second segment providing at least a portion of the second resistance and extending laterally from the base segment in a second direction that is substantially opposite the first direction.

10. The attenuator circuit of claim 9, wherein the first segment has a first width, and the second segment has a second width that is different from the first width.

11. The attenuator circuit of claim 9, wherein the first segment has a first length, and the second segment has a second length that is different from the first length.

12. The attenuator circuit of claim 11, wherein the first segment has a first width, and the second segment has a second width that is different from the first width.

13. The attenuator circuit of claim 1,
wherein the series impedance element has a first end and a second end, the first shunt impedance element coupling the first end to the ground conductor, the second shunt impedance element coupling the first end to the ground conductor; and
wherein the attenuator circuit further comprises:
a third shunt impedance element providing a primarily capacitive reactance and coupling the second end to the ground conductor, and
a fourth shunt impedance element providing a primarily inductive reactance and coupling the second end to the ground conductor; the fourth shunt impedance element electrically separate from and extending electrically in parallel with the third shunt impedance element.

14. The attenuator circuit of claim 13, wherein the third shunt impedance element and the fourth shunt impedance element are configured to provide a substantially constant resultant impedance between the series impedance element and the ground conductor over a frequency range.

15. The attenuator circuit of claim 14, wherein the frequency range is at least partially between 0 Hz and 110 GHz.

16. The attenuator circuit of claim 13, wherein the third shunt impedance element and the fourth shunt impedance element are configured to provide a primarily resistive resultant impedance between the series impedance element and the ground conductor over a frequency range.

17. The attenuator circuit of claim 13, wherein the first shunt impedance element includes a first shunt resistor, the second shunt impedance element includes a second shunt resistor, the third shunt impedance element includes a third shunt resistor, the fourth shunt impedance element includes a fourth shunt resistor, the attenuator further comprising:
an insulating substrate having a first surface opposite a second surface; and
a resistive assembly formed at least partially from at least a portion of a resistive layer that extends along the first surface, the resistive assembly including the series impedance element, the first shunt resistor, the second shunt resistor, the third shunt resistor, and the fourth shunt resistor.

18. The attenuator circuit of claim 17, wherein the resistive assembly further includes at least a portion of at least one conductive element electrically disposed between the first shunt resistor and the second shunt resistor.

19. The attenuator circuit of claim 18, wherein at least a portion of at least one conductive element or at least a portion of at least another conductive element is electrically disposed between the third shunt resistor and the fourth shunt resistor.

20. The attenuator circuit of claim 13, wherein an impedance of the first impedance element is substantially equal to an impedance of the third impedance element.

21. An attenuator circuit, comprising:
a ground conductor;
an input conductor;
an output conductor;
a series impedance element providing a series resistance and disposed in a current path between the input conductor and the output conductor; and
a first shunt circuit that includes a first shunt impedance element and a second shunt impedance element, the first and second shunt impedance elements providing parallel current paths to the ground conductor from a first common junction node associated with the series impedance element,
the first shunt impedance element providing a first impedance that includes a first resistance and a primarily capacitive first reactance,
the second shunt impedance element providing a second impedance that includes a second resistance and a primarily inductive second reactance.

22. The attenuator circuit of claim 21, wherein the first shunt impedance element and the second shunt impedance element are configured to provide a substantially constant resultant impedance between the series impedance element and the ground conductor over a frequency range.

23. The attenuator circuit of claim 22, wherein the frequency range is at least partially between 0 Hz and 110 GHz.

24. The attenuator circuit of claim 21, wherein the first shunt impedance element and the second shunt impedance element are configured to provide a primarily resistive resultant impedance between the series impedance element and the ground conductor over a frequency range.

25. The attenuator circuit of claim 21,
wherein the series impedance element has a first end electrically coupled to the first common junction node and a second end; and
wherein the attenuator circuit further comprises a second shunt circuit that includes a third shunt impedance element and a fourth shunt impedance element, the third and fourth shunt impedance elements providing parallel current paths to the ground conductor from a second common junction node electrically coupled to the second end of the series impedance element,
the third shunt impedance providing a third impedance including a third resistance and a primarily capacitive third reactance, and
the fourth shunt impedance element providing a fourth impedance including a fourth resistance and a primarily inductive fourth reactance.

26. The attenuator circuit of claim 25, wherein the third shunt impedance element and the fourth shunt impedance element are configured to provide a substantially constant resultant impedance between the series impedance element and the ground conductor over a frequency range.

27. The attenuator circuit of claim 26, wherein the frequency range is at least partially between 0 Hz and 110 GHz.

28. The attenuator circuit of claim 25, wherein the third shunt impedance element and the fourth shunt impedance element are configured to provide a primarily resistive resultant impedance between the series impedance element and the ground conductor over a frequency range.

29. A coplanar attenuator, comprising:
an insulating substrate having a first surface opposite a second surface;
a planar ground conductor extending along the second surface;
a resistive assembly including a plurality of segments fabricated from at least a portion of a resistive layer extending along the first surface;
one or more connecting conductors extending between the ground conductor and the first surface of the insulating substrate; and
a plurality of conductive elements that are each fabricated from a portion of an electrically conductive layer extending along the first surface, the plurality of conductive elements including:
an open-circuit, first ground shunt conductor electrically coupled to and extending from a first segment of the resistive assembly, the first ground shunt conductor capacitively coupling the first segment to the planar ground conductor,
a second ground shunt conductor electrically coupled to and extending between a second segment of the resistive assembly and a corresponding connecting conductor, the second segment being on a first side of the resistive assembly substantially opposite the first segment,
an input conductor electrically coupled to and extending from a third segment of the resistive assembly, the third segment being disposed between the first segment and the second segment, and
an output conductor electrically coupled to and extending from a fourth segment of the resistive assembly, the fourth segment being disposed on a second side of the resistive assembly substantially opposite the third segment.

30. The coplanar attenuator of claim 29, wherein the resistive assembly further includes an intermediate segment fabricated from a portion of the resistive layer, the intermediate segment electrically coupling and extending between the first, second, third, and fourth segments.

31. The coplanar attenuator of claim 29, wherein the resistive assembly further includes an intermediate segment fabricated from a portion of the conductive layer, the intermediate segment electrically coupling and extending between the first, second, third, and fourth segments.

32. The coplanar attenuator of claim 29,
wherein the resistive assembly further includes a base segment extending between the input conductor and the output conductor, the base segment including the third segment, the fourth segment, and an intermediate segment extending between the third and fourth segments;
wherein the first and second segments extend laterally from the intermediate segment;
wherein the first segment has a substantially uniform width; and
wherein the second segment has a substantially uniform width that is different from the width of the first segment.

33. The coplanar attenuator of claim 29,
wherein the resistive assembly further includes a base segment extending between the input conductor and the output conductor, the base segment including the third segment, the fourth segment, and an intermediate segment extending between the third and fourth segments;
wherein the first and second segments extend laterally from the intermediate segment;
wherein the first segment has a length; and
wherein the second segment has a length that is different from the length of the first segment.

34. The coplanar attenuator of claim 33, wherein the first segment has a substantially uniform width; and the second segment has a substantially uniform width that is different from the width of the first segment.

35. The coplanar attenuator of claim 29, wherein the plurality of conductive elements further include:
an open-circuit, fifth ground shunt conductor electrically coupled to and extending from a fifth segment of the resistive assembly, the fifth ground shunt conductor capacitively coupling the fifth segment to the planar ground conductor, and
a sixth ground shunt conductor electrically coupled to and extending between a sixth segment of the resistive assembly and a corresponding connecting conductor, the sixth segment being on the first side of the resistive assembly substantially opposite the fifth segment; and
wherein the resistive assembly further includes an intermediate segment fabricated from a portion of the resistive layer, the intermediate segment electrically coupling and extending between the first, second, third, fourth, fifth, and sixth segments.

36. The coplanar attenuator of claim 29, wherein the plurality of conductive elements further include:
an open-circuit, fifth ground shunt conductor electrically coupled to and extending from a fifth segment of the resistive assembly, the fifth ground shunt conductor capacitively coupling the fifth segment to the planar ground conductor, and
a sixth ground shunt conductor electrically coupled to and extending between a sixth segment of the resistive assembly and a corresponding connecting conductor, the sixth segment being on the first side of the resistive assembly substantially opposite the fifth segment; and
wherein the resistive assembly further includes an intermediate segment fabricated from a portion of the conductive layer, the intermediate segment electrically coupling and extending between the first, second, third, fourth, fifth, and sixth segments.
